(19) United States
(12) Patent Application Publication
(10) Pub. No.: US 2019/0137016 A1
(43) Pub. Date: May 9, 2019

(54) CONNECTING UNION JOINT WITH SMART CONNECTION OF EASY-FLOWING PIPE SYSTEM

(71) Applicant: Shanghai Sansheng Metal Products. Co. Ltd., Shanghai (CN)

(72) Inventors: Bin SHENG, Taizhou (CN); He YANG, Shanghai (CN); Zhixia FU, Shanghai (CN)

(73) Assignee: Shanghai Sansheng Metal Products. Co. Ltd., Shanghai (CN)

(21) Appl. No.: 15/920,465

(22) Filed: Mar. 14, 2018

(30) Foreign Application Priority Data
Nov. 8, 2017 (CN) 2017110910257
Nov. 8, 2017 (CN) 2017214810569

(51) Int. Cl. F16L 21/02; F16L 21/03; F16L 21/08; F16L 37/096

(52) U.S. Cl. CPC F16L 21/022; F16L 37/096; F16L 21/08; F16L 21/03

(57) ABSTRACT

A connecting union joint with smart connection of an easy-flowing pipe system includes a joint body, wherein an end of the joint body is provided with a pipe connecting device which includes a sliding base, a snapping tooth piece, a reset spring, a spring pad and a snapping ring. The joint body is internally provided with a snap slot. The reset spring is arranged between the spring pad and the sliding base. The sliding base is evenly provided with a plurality of through openings. tooth The snapping tooth of the snapping tooth piece deeply extend into an inner wall of the sliding base and are snapped with an outer peripheral surface of the pipe. An inner wall of the joint body is provided with a moving area for allowing the snapping tooth piece to move therein.

### CROSS REFERENCE TO RELATED APPLICATIONS

This application is based upon and claims priority to Chinese Patent Application No. 201711091025.7, filed on Nov. 8, 2017, the entire contents of which are incorporated herein by reference.

### TECHNICAL FIELD

The present invention relates to the technical field of connecting devices, and particularly to a connecting union joint with smart connection of an easy-flowing pipe system.

### BACKGROUND

Currently, joints are usually used to connect the pipes in pipe connections. Most of the existing union joints of pipes are fastened through methods of threads or clamp hoops. However, these types of joints are difficult to assemble and disassemble and loosen easily when in use. Also, the seal provided by these types of joints is undesirable, and the clamp hoops have a poor connection strength and a short service life. Therefore, improvements are necessary.

### SUMMARY OF THE INVENTION

The objective of the present invention is to provide a connecting union joint with smart connection of an easy-flowing pipe system which has the characteristics of easy assembly and disassembly, good sealing, and long service life, addressing the drawbacks and shortcomings of the prior art.

In order to achieve the above-mentioned objectives, the technical solutions of the present invention are as follows. A connecting union joint with smart connection of an easy-flowing pipe system includes a joint body, wherein an end of the joint body is provided with a pipe connecting device. The pipe connecting device includes a sliding base, a snapping tooth piece, a reset spring, a spring pad and a snapping ring. The sliding base is slidably arranged inside the joint body. The joint body is internally provided with a snap slot. The snapping ring is snapped within the snap slot, and the snapping ring is in a snap-fit relationship with the sliding base. One end of the reset spring abuts against the spring pad, and the other end of the reset spring abuts against the sliding base. The spring pad is fixedly arranged inside the joint body. The sliding base is evenly provided with a plurality of through openings that cut through an inner end surface and an outer end surface of the sliding base. The snapping tooth piece is arranged inside the through openings. The snapping tooth of the snapping tooth piece deeply extends into an inner wall of the sliding base and is snapped with an outer peripheral surface of the pipe. An inner wall of the joint body is provided with a moving area for allowing the snapping tooth piece to move therein.

Furthermore, the connecting union joint with smart connection of an easy-flowing pipe system further includes a support pad and a first seal ring. The support pad is fixedly arranged inside the joint body. One end of the first seal ring abuts against the support pad, and the other end of the first seal ring abuts against an end surface of the spring pad.

A second seal ring is arranged between the support pad and an inner bottom surface of the joint body. One end of the second seal ring abuts against an end surface of the support pad, and the other end of the second seal ring abuts against the inner bottom surface of the joint body.

The moving area in the joint body is an inclined surface that inclines downward.

The spring pad is provided with a first convex part. An end surface of the sliding base is provided with a second convex part. One end of the reset spring is sleeved around the first convex part, and the other end of the reset spring is sleeved around the second convex part.

Compared with the prior art, the present invention has the following advantages by using the above-mentioned structure. The snapping tooth of the snapping tooth piece is sapped with the pipe according to the present invention. This type of snapping manner is tighter and more stable compared with the prior art. Moreover, the assembly and disassembly of the pipes can be accomplished by pushing the sliding base, so that the present invention is very convenient.

### BRIEF DESCRIPTION OF THE DRAWINGS

FIG. 1 is a plan view showing the structure of the present invention in use state.

FIG. 2 is a structural schematic view of the sliding base of the present invention.

FIG. 3 is a structural schematic plan view showing the structure of the snapping tooth piece of the present invention.

### DETAILED DESCRIPTION OF THE INVENTION

The following description is merely preferred embodiments of the present invention which is not intended to limit the protection scope of the present invention. The present invention will be further described with reference to the drawings and embodiments hereinafter.

### Embodiment

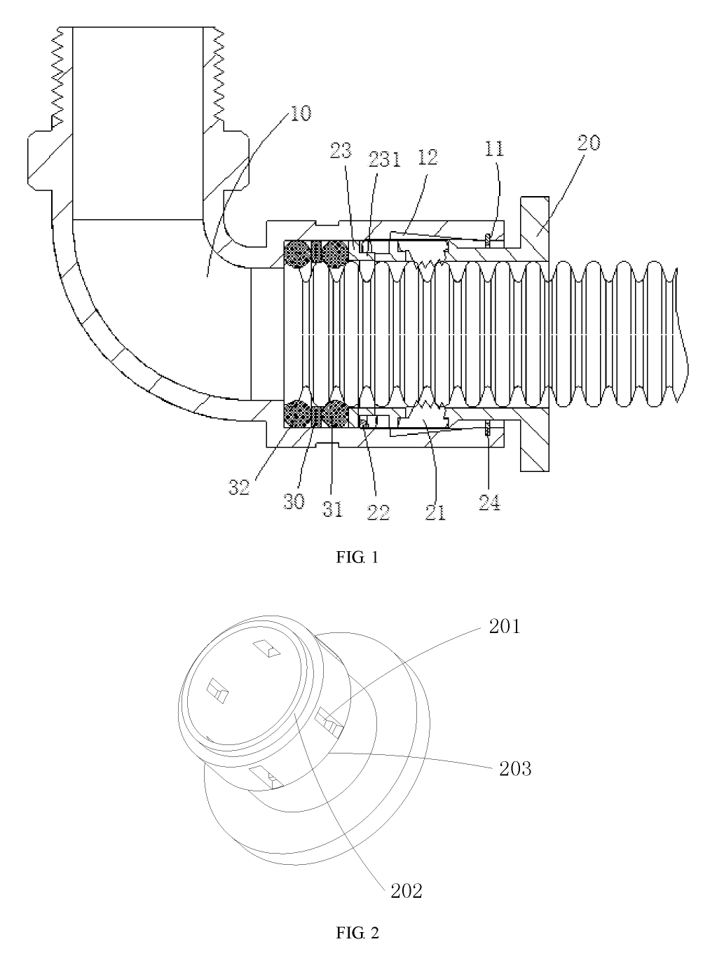

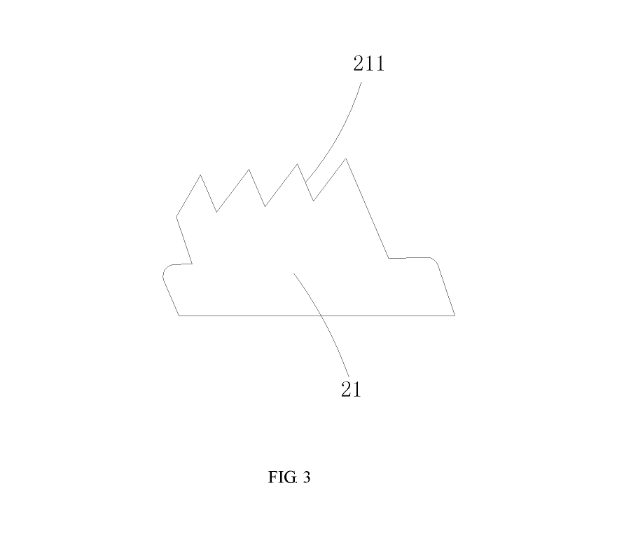

As shown in FIG. 1 to FIG. 3, a connecting union joint with smart connection of an easy-flowing pipe system includes a joint body 10. The joint body 10 is a two-end through structure which may be a straight-through structure or an elbow structure. An end of the joint body 10 is provided with a pipe connecting device. The pipe connecting device includes a sliding base 20, a snapping tooth piece 21, a reset spring 22, a spring pad 23 and a snapping ring 24. The sliding base 20 is slidably arranged inside the joint body 10. The sliding base is internally provided with a through hole for the pipe to pass. The joint body 10 is internally provided with a snap slot 11. The snapping ring 24 is snapped within the snap slot 11. The sliding base 20 is configured with a snapping end surface 203 for snapping with the snapping ring 24, so that the sliding base 20 can be prevented from sliding out of the joint body 10 through a snapping and positioning between the snapping end surface 203 and the snapping ring 24. The spring pad 23 is fixedly arranged inside the joint body 10. The spring pad 23 is provided with a first convex part 231. A front end surface of the sliding base 20 is provided with a second convex part 202. One end of the reset spring 22 is sleeved around the first convex part 231. The other end of the reset spring is sleeved around the second convex part 202. The reset spring 22 enables the sliding base 20 to return to its original position after sliding, namely, the snapping end surface 203 on the sliding base 20 abuts against the snapping ring 24 the through an elastic force. The sliding base 20 is evenly provided with a plurality of through openings 201 that cut through an inner end surface and an outer end surface of the sliding base. The through openings 201 are internally configured with steps, while the snapping tooth piece is also configured with steps. The steps are matched with each other. An outer side surface of the snapping tooth piece has an inclined structure which is snapped in the through opening 201. The snapping tooth 211 of the snapping tooth piece 21 deeply extends into an inner wall of the sliding base 20 and is snapped with an outer peripheral surface of the pipe. The structure that the snapping tooth 211 is snapped with an outer peripheral surface of the pipe is more stable and has a longer service life than the existing structure. An inner wall of the joint body 10 is provided with a moving area 12 for allowing the snapping tooth piece 21 to move therein. The moving area 12 is an inclined surface that inclines downward. When the sliding base 20 is pushed inwardly, the snapping tooth piece 21 is pushed to rotate downward by the through opening 201 and rotate into the inclined surface, so that the snapping tooth 211 can be separated from the outer peripheral surface of the pipe, and thus the pipe can be disassembled easily. When the pipe needs to be assembled, the sliding base 20 is also pushed inward, so that the snapping tooth piece 21 would rotate into the moving area 12. At this time, the snapping tooth are held within the through opening 201. After the pipe is inserted, the sliding base 20 is released. Under the action of the reset spring 22, the sliding base 20 will move toward the outer side. Meanwhile, the through opening 201 would drive the snapping tooth piece 21 to return back to the original position and the snapping tooth 211 would be snapped with the outer peripheral surface of the pipe. After the sliding base 20 moves for a certain distance, the snapping end surface 203 on the sliding base 20 would be snapped with a snapping ring 24, so that the positioning function is achieved.

The joint body 10 is internally provided with a support pad 30, a first seal ring 31 and a second seal ring 32. The support pad 30 is fixedly arranged inside the joint body 10. One end of the first seal ring 31 abuts against the support pad 30. The other end of the first seal ring abuts against the end surface of the spring pad 23. One end of the second seal ring 32 abuts against the end surface of the support pad 30. The other end of the second seal ring 32 abuts against the inner bottom surface of the joint body 10. The first seal ring 31 and the second seal ring can increase the sealing in use.

What is claimed is:

1. A connecting union joint with smart connection of an easy-flowing pipe system comprising a joint body, wherein an end of the joint body is provided with a pipe connecting device,
the pipe connecting device comprises: a sliding base, a snapping tooth piece, a reset spring, a spring pad and a snapping ring; wherein,
the sliding base is slidably arranged inside the joint body;
the joint body is internally provided with a snap slot;
the snapping ring is snapped within the snap slot;
the snapping ring is in snap-fit with the sliding base;
one end of the reset spring abuts against the spring pad;
the other end of the reset spring abuts against the sliding base;
the spring pad is fixedly arranged inside the joint body;
the sliding base is evenly provided with a plurality of through openings that cut through an inner end surface and an outer end surface of the sliding base;
the snapping tooth piece is arranged inside the through openings;
the snapping tooth of the snapping tooth piece deeply extends into an inner wall of the sliding base and is snapped with an outer peripheral surface of the pipe; and
an inner wall of the joint body is provided with a moving area for allowing the snapping tooth piece to move therein.

2. The connecting union joint with smart connection of an easy-flowing pipe system of claim 1, wherein, the connection union joint further comprises:
a support pad and a first seal ring;
the support pad is fixedly arranged inside the joint body;
one end of the first seal ring abuts against the support pad; and
the other end of the first seal ring abuts against an end surface of the spring pad.

3. The connecting union joint with smart connection of an easy-flowing pipe system of claim 2, wherein,
a second seal ring is arranged between the support pad and an inner bottom surface of the joint body;
one end of the second seal ring abuts against an end surface of the support pad; and
the other end of the second seal ring abuts against the inner bottom surface of the joint body.

4. The connecting union joint with smart connection of an easy-flowing pipe system of claim 3, wherein,
the moving area in the joint body is a downwardly inclined surface.

5. The connecting union joint with smart connection of an easy-flowing pipe system of claim 4, wherein,
the spring pad is provided with a first convex part;
an end surface of the sliding base is provided with a second convex part);
one end of the reset spring is sleeved around the first convex part; and
the other end of the reset spring is sleeved around the second convex part.
